(19) United States
(12) Patent Application Publication
(10) Pub. No.: US 2020/0301310 A1
(43) Pub. Date: Sep. 24, 2020

(54) DEVELOPING DEVICE AND IMAGE FORMING DEVICE

(71) Applicant: FUJI XEROX CO., LTD., Tokyo (JP)

(72) Inventors: Shinichi KURAMOTO, Kanagawa (JP); Yoshifumi OZAKI, Kanagawa (JP); Masanori KATO, Kanagawa (JP); Yoshitaka NAKAJIMA, Kanagawa (JP); Norihiro TAMAZAWA, Kanagawa (JP); Tomoyuki YOSHII, Kanagawa (JP); Shigeru INABA, Kanagawa (JP)

(73) Assignee: FUJI XEROX CO., LTD., Tokyo (JP)

(21) Appl. No.: 16/513,887

(22) Filed: Jul. 17, 2019

(30) Foreign Application Priority Data
Mar. 22, 2019 (JP) 2019-055393

(51) Int. Cl. G03G 15/08

(52) U.S. Cl. CPC G03G 15/0812; G03G 15/0891; G03G 15/087

(57) ABSTRACT

A developing device includes: a housing unit that has an opening and houses a developer; a conveying member that is installed within the housing unit and conveys the developer; a first rotating member that has an outer peripheral surface to which the developer conveyed by the conveying member adheres; a regulating unit that protrudes above a movement path of the developer that adheres to the outer peripheral surface and moves due to rotation of the first rotating member, and regulates movement of some of the developer on the outer peripheral surface; and a second rotating member that is installed in the opening and has supplied thereto the developer that has moved through a gap between the first rotating member and the regulating unit.

### CROSS-REFERENCE TO RELATED APPLICATIONS

This application is based on and claims priority under 35 USC 119 from Japanese Patent Application No. 2019-055393 filed Mar. 22, 2019.

### BACKGROUND

### (i) Technical Field

The present disclosure relates to a developing device and an image forming device.

### (ii) Related Art

Japanese Unexamined Patent Application Publication No. 2011-169931 discloses a developing device provided with a control unit that controls the strength of a magnetic field generated in a portion adjoining a developer rectifying space, in accordance with the development conditions when a toner image is formed on an image carrier.

### SUMMARY

In developing devices, development is sometimes carried out with a rotating body being installed in an opening of the developing device and a developer that has adhered to this rotating body being made to adhere to a development subject.

In developing devices, a conveying member that conveys the developer is sometimes provided, and when the developer is supplied directly from this conveying member to the rotating body, the quantity of the developer that adheres to the rotating body is liable to fluctuate.

Aspects of non-limiting embodiments of the present disclosure relate to a developing device and an image forming device, a purpose of which is to stabilize the quantity of a developer that is supplied to a rotating member installed in an opening of the developing device, compared to when a developer is supplied directly from a conveying member installed in a developing device to a rotating member installed in an opening of the developing device.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a developing device including: a housing unit that has an opening and houses a developer; a conveying member that is installed within the housing unit and conveys the developer; a first rotating member that has an outer peripheral surface to which the developer conveyed by the conveying member adheres; a regulating unit that protrudes above a movement path of the developer that adheres to the outer peripheral surface and moves due to rotation of the first rotating member, and regulates movement of some of the developer on the outer peripheral surface; and a second rotating member that is installed in the opening and has supplied thereto the developer that has moved through a gap between the first rotating member and the regulating unit.

### BRIEF DESCRIPTION OF THE DRAWINGS

An exemplary embodiment of the present disclosure will be described in detail based on the following figures, wherein:

FIG. 1 is a drawing depicting the overall configuration of an image forming device;

FIG. 2 is a drawing describing a developing device; and

FIG. 3 is a drawing depicting another exemplary configuration of the developing device.

### DETAILED DESCRIPTION

Hereinafter, an exemplary embodiment of the present disclosure will be described with reference to the appended drawings.

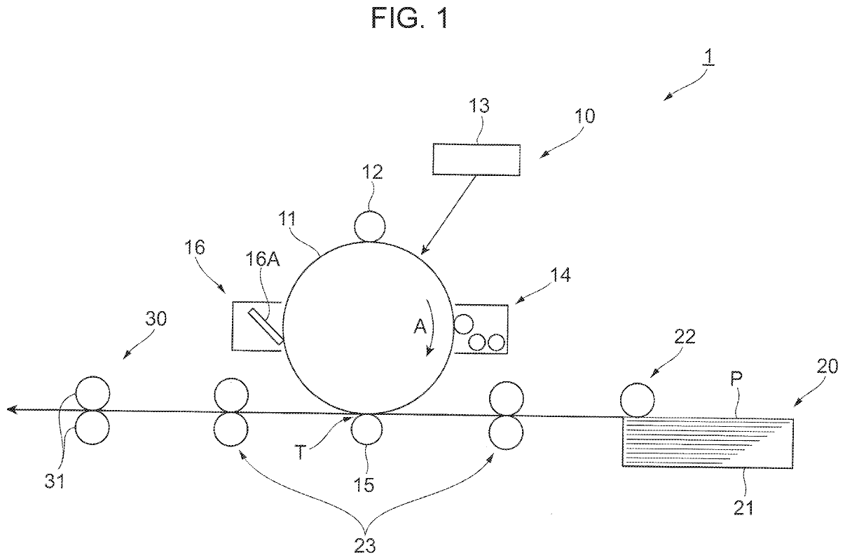

FIG. 1 is a drawing depicting the overall configuration of an image forming device 1. That is to say, FIG. 1 is a drawing of a case where the image forming device 1 is viewed from the front side of the image forming device 1.

The image forming device 1 is provided with an image forming unit 10, a paper supply unit 20, and a fixing unit 30.

The image forming unit 10 forms an image (toner image) that is transferred onto paper P, using what is referred to as an electrophotographic system. The paper supply unit 20 supplies the paper P to the image forming unit 10. The fixing unit 30 fixes the image formed on the paper P by the image forming unit 10, to the paper P.

The image forming unit 10 is provided with a photoconductor drum 11 that rotates in the direction indicated by arrow A. Furthermore, the image forming unit 10 is provided with a charging roller 12, an exposing device 13, a developing device 14, a transfer roller 15, and a cleaning device 16.

The photoconductor drum 11, which serves as an example of the image carrier, is constituted by a cylindrical body. A photosensitive layer (not depicted) is formed on the surface of this cylindrical body.

The charging roller 12 is constituted by an electrically conductive rubber roller or the like, and charges the photoconductor drum 11.

The exposing device 13 radiates light from a light source such as a laser light source or an LED (light emitting diode) toward the photoconductor drum 11 that is charged by the charging roller 12, and forms an electrostatic latent image on the surface of the photoconductor drum 11.

The developing device 14 houses a developer. The developer of the present embodiment is constituted by a magnetic carrier and a colored toner, and is what is referred to as a two-component developer.

The developing device 14 causes the developer to adhere to the surface of the photoconductor drum 11, and develops the electrostatic latent image formed on the photoconductor drum 11, using the developer having a predetermined color. An image formed using a toner is thereby formed on the surface of the photoconductor drum 11.

The transfer roller 15 functions as a transfer unit and is constituted by a roller-shaped member or the like that is electrically conductive. In the present embodiment, the location where the transfer roller 15 and the photoconductor drum 11 oppose each other serves as a transfer section T, and the image on the surface of the photoconductor drum 11 is transferred to conveyed paper P in this transfer section T.

The cleaning device 16 is provided with a contact member 16A that is arranged in contact with the photoconductor drum 11, and the cleaning device 16 eliminates adhered substances (such as toner) on the photoconductor drum 11.

The paper supply unit 20 is provided with a housing container 21 that houses the paper P, and a feeding mechanism 22 that feeds the paper P from the housing container 21.

In addition, in the present embodiment, there are provided paper conveying mechanisms 23 that convey the paper P that is fed from the housing container 21, through the transfer section T and the fixing unit 30.

The fixing unit 30 is provided with a pair of rotating bodies 31 that rotate while in contact with each other.

A heating source (not depicted) is provided within one rotating body 31 from among this pair of rotating bodies 31.

In the fixing unit 30, pressure and heat are applied to the paper P by these two rotating bodies 31, and the toner image on the paper P is fixed to this paper P.

An image forming operation in the image forming device 1 will now be described.

In the image forming unit 10, the photoconductor drum 11, which rotates in the direction of arrow A, is charged by the charging roller 12. Next, the exposing device 13 carries out exposure, and an electrostatic latent image corresponding to image information is formed on the surface of the photoconductor drum 11.

Thereafter, the developing device 14 carries out developing, and an image (toner image) corresponding to the electrostatic latent image is formed on the surface of the photoconductor drum 11.

The toner image formed on the photoconductor drum 11 moves toward the transfer section T due to the rotation of the photoconductor drum 11. Furthermore, the paper P fed from the housing container 21 is conveyed to the transfer section T by the paper conveying mechanisms 23.

The toner image on the photoconductor drum 11 is then transferred to the conveyed paper P in the transfer section T. Thereafter, the paper P to which the toner image has been transferred passes through the fixing unit 30 and has heat and pressure thereby applied thereto, and this toner image is fixed on the paper P.

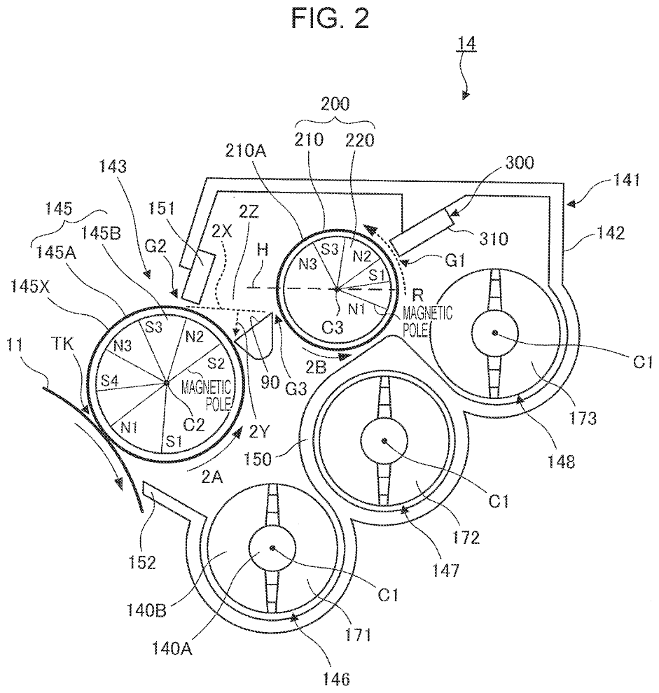

FIG. 2 is a drawing describing the developing device 14. The developing device 14 is provided with a housing unit 141 that houses the developer therein. The housing unit 141 is constituted by a housing casing 142 made of a resin.

The housing casing 142 (developing device 14) is arranged so as to extend in the direction from the front side of the image forming device 1 to the rear side (direction orthogonal to the page space in FIG. 2), has a rear side end (not depicted) at the rear side, and has a front side end (not depicted) at the front side.

In the housing unit 141, an opening 143, which serves as an example of the opening, is provided in a location opposing the photoconductor drum 11 (see FIG. 1).

A developing roller 145 is provided in this opening 143. This developing roller 145 causes the developer to adhere to the surface of the photoconductor drum 11.

The developing roller 145 is formed in a cylindrical shape and is arranged so as to extend in the direction from the front side of the image forming device 1 to the rear side (direction orthogonal to the page space in FIG. 2).

The developing roller 145 is provided with a developing sleeve 145A that is constituted by a cylindrical body and rotates in the direction of arrow 2A in the drawing by means of an undepicted drive source.

Furthermore, the developing roller 145 is provided with a magnet roller 145B arranged at the inner side of the developing sleeve 145A.

The developing sleeve 145A, which serves as an example of the second rotating member, is a cylindrical member and is formed of a metal such as SUS, for example.

In the present embodiment, the developer within the housing unit 141 is supplied to an outer peripheral surface 145X of the developing sleeve 145A, and the developer is then supplied to the photoconductor drum 11.

As mentioned above, the developing sleeve 145A rotates in the direction of arrow 2A in the drawing. In other words, the developing sleeve 145A rotates in such a way that the portion facing the inner side of the housing unit 141 (the portion located at the inner side of the housing unit 141) moves upward.

In addition, in the present embodiment, the developing sleeve 145A and the photoconductor drum 11 rotate in such a way that the developing sleeve 145A and the photoconductor drum 11 move in the same direction in an opposing section TK between the developing roller 145 and the photoconductor drum 11.

Multiple magnetic poles that generate magnetic fields are arranged within the magnet roller 145B. The developer constituted by a toner and a carrier is adhered to the outer peripheral surface 145X of the developing sleeve 145A due to the magnetic fields generated by the magnetic poles.

Furthermore, in the present embodiment, due to the developing sleeve 145A rotating counterclockwise in the drawing, the developer adhered to the outer peripheral surface 145X of the developing sleeve 145A moves to the opposing section TK.

Furthermore, as depicted in FIG. 2, a first conveying member 146, a second conveying member 147, and a third conveying member 148 that convey the developer are provided within the housing unit 141.

Each of the first conveying member 146, the second conveying member 147, and the third conveying member 148 is provided with a rotating shaft 140A that rotates by means of an undepicted drive source, and a pushing unit 140B that is provided around the rotating shaft 140A and pushes the developer in the axial direction of the rotating shaft 140A.

The pushing unit 140B is provided around the rotating shaft 140A. Furthermore, the pushing unit 140B is formed in a spiral shape.

In the present embodiment, when positions in the horizontal direction are compared, the first conveying member 146 is provided at the side nearest the developing roller 145 and the third conveying member 148 is provided at the side furthest from the developing roller 145.

Furthermore, in the horizontal direction, the second conveying member 147 is located between the first conveying member 146 and the third conveying member 148.

Furthermore, in the present embodiment, when positions in the vertical direction are compared, the first conveying member 146 is provided in the lowest position and the third conveying member 148 is provided in the highest position.

Furthermore, in the vertical direction, the second conveying member 147 is located between the first conveying member 146 and the third conveying member 148.

In addition, when the rotation center C1 of each conveying member and the rotation center C2 of the developing sleeve 145A are compared, in the present embodiment, the rotation centers C1 of the first conveying member 146 and the second conveying member 147 are located lower than the rotation center C2 of the developing sleeve 145A.

Furthermore, the rotation center C1 of the third conveying member 148 is located higher than the rotation center C2 of the developing sleeve 145A.

The first conveying member 146 is arranged so as to extend in the direction from the front side of the image forming device 1 to the rear side (arranged so as to extend in the direction orthogonal to the page space in FIG. 2), and conveys the developer in the rear side direction of the page space in FIG. 2 (conveys to the rear side of the image forming device 1), for example.

Furthermore, the second conveying member 147 is also arranged so as to extend in the direction from the front side of the image forming device 1 to the rear side (arranged so as to extend in the direction orthogonal to the page space in FIG. 2).

The second conveying member 147 conveys the developer in the direction toward the front side of the page space in FIG. 2 (conveys to the front side of the image forming device 1), for example.

Furthermore, the third conveying member 148 is also arranged so as to extend in the direction from the front side of the image forming device 1 to the rear side (arranged so as to extend in the direction orthogonal to the page space in FIG. 2).

The third conveying member 148 conveys the developer in the rear side direction of the page space in FIG. 2 (conveys to the rear side of the image forming device 1), for example.

In addition, in the present embodiment, the space within the housing casing 142 is partitioned by a partition wall 150, and a first housing space 171 that houses the first conveying member 146, a second housing space 172 that houses the second conveying member 147, and a third housing space 173 that houses the third conveying member 148 are provided within the housing casing 142.

The partition wall 150 is not formed across the entire housing casing 142 in the longitudinal direction, and the partition wall 150 is not provided at the rear side end and the front side end of the housing casing 142.

That is to say, a non-formed portion in which the partition wall 150 is not formed is present at both end sections of the housing casing 142 in the longitudinal direction.

Thus, in the present embodiment, the developer moves through the first housing space 171, the second housing space 172, and the third housing space 173 in this order.

Specifically, in the present embodiment, the developer within the first housing space 171 is conveyed in the rear side direction of the page space in FIG. 2 by the first conveying member 146. Then, upon reaching the rear side end of the housing casing 142, this developer moves toward the second housing space 172 through a non-formed portion.

Then, the developer that has moved into the second housing space 172 is conveyed to the front side end of the housing casing 142 by the second conveying member 147. Then, this developer moves into the third housing space 173 through the non-formed portion at the front side end.

Then, this developer that has moved into the third housing space 173 is conveyed to the rear side end of the housing casing 142 by the third conveying member 148.

It should be noted that, out of the developer conveyed by the third conveying member 148, developer that has moved to the rear side end of the housing casing 142 without being supplied to a movement roller (described later) moves toward the second housing space 172 through the non-formed portion provided at the rear side end.

Then, this developer that has moved to the second housing space 172 is once again supplied to the third housing space 173 via this second housing space 172.

In the present embodiment, the second housing space 172 and the third housing space 173 form a configuration provided with an annular path along which the developer moves.

In addition, in the present embodiment, a movement roller 200 for moving the developer from the third conveying member 148 to the developing roller 145 is provided in a location adjacent to the third conveying member 148.

The movement roller 200 is arranged so as to extend in the direction from the front side of the image forming device 1 to the rear side (arranged so as to extend in the direction orthogonal to the page space in FIG. 2).

Furthermore, the movement roller 200 is arranged along the third conveying member 148.

Furthermore, the movement roller 200 is provided with a movement sleeve 210 that is constituted by a cylindrical body and rotates by means of an undepicted drive source, and a magnet roller 220 that is arranged at the inner side of the movement sleeve 210.

The movement sleeve 210, which serves as an example of the first rotating member, is a cylindrical member and is formed of a metal such as SUS, for example.

In the present embodiment, developer conveyed by the third conveying member 148 adheres to an outer peripheral surface 210A of this movement sleeve 210 due to a magnetic force generated by the magnet roller 220.

Then, in the present embodiment, the developer that has adhered to the outer peripheral surface 210A of the movement sleeve 210 moves downstream due to rotation of the movement sleeve 210.

The movement sleeve 210 rotates in the direction of arrow 2B in the drawing. In other words, the movement sleeve 210 rotates in such a way that the portion located near the third conveying member 148 moves upward.

Multiple magnetic poles that generate magnetic fields are arranged within the magnet roller 220. In the present embodiment, the developer adheres to the outer peripheral surface 210A of the movement sleeve 210 due to the magnetic fields generated by these magnetic poles.

Furthermore, in the present embodiment, the developer that has adhered to the outer peripheral surface 210A of the movement sleeve 210 moves downstream due to the movement sleeve 210 rotating in the direction of arrow 2B in the drawing.

In addition, in the present embodiment, a regulating unit 300 that regulates the movement of the developer on the outer peripheral surface 210A of the movement sleeve 210 is provided in a position opposing the outer peripheral surface 210A of the movement sleeve 210.

The regulating unit 300 protrudes above a movement path R of the developer that moves due to the rotation of the movement sleeve 210, and regulates the movement of some of the developer located on this movement path R.

That is to say, the regulating unit 300 protrudes above this movement path R from a side of the movement path R, and regulates the movement of some of the developer that moves downstream.

The regulating unit 300 is provided at the opposite side of the movement roller 200 to the side where the developing roller 145 is installed.

Furthermore, the regulating unit 300 is provided with a regulating surface 310 with which moving developer collides, and the movement of some of the developer is regulated using this regulating surface 310.

The regulating surface 310 faces upstream in the movement direction of the developer. Furthermore, the regulating surface 310 faces downward in the vertical direction.

In addition, the regulating surface 310 (regulating unit 300) is arranged with there being a gap G1 between the regulating surface 310 and the outer peripheral surface 210A of the movement sleeve 210, and is arranged so as to extend in the direction away from the outer peripheral surface 210A.

That is to say, in the present embodiment, the gap G1 is provided between the outer peripheral surface 210A of the movement sleeve 210 and an end of the regulating surface 310 (the end at the outer peripheral surface 210A side).

Furthermore, in the present embodiment, the regulating surface 310 is arranged in the radial direction of the movement sleeve 210.

Furthermore, in the present embodiment, the regulating unit 300 is arranged in a position opposing the magnetic poles with the movement sleeve 210 therebetween. That is to say, in the present embodiment, multiple magnetic poles that generate magnetic fields are provided in the magnet roller 220; however, the regulating unit 300 is arranged in a position opposing one magnetic pole included in these multiple magnetic poles.

Napping of the developer easily occurs in a position opposing a magnetic pole, and the movement of the developer in a napped state is regulated when the regulating unit 300 is provided in a position opposing a magnetic pole.

In addition, in the present embodiment, the regulating unit 300 is arranged above the third conveying member 148. More specifically, in the present embodiment, the regulating unit 300 and the third conveying member 148 are arranged in such a way that the regulating unit 300 and the third conveying member 148 overlap when the regulating unit 300 and the third conveying member 148 are viewed from above or below in the vertical direction.

In addition, in the present embodiment, a rotation center C3 of the movement sleeve 210 is located higher up than the rotation center C1 of the third conveying member 148.

In the present embodiment, when developer adheres to the outer peripheral surface 210A of the movement sleeve 210, this developer moves downstream due to the rotation of the movement sleeve 210.

That is to say, in the present embodiment, assuming there is a horizontal plane H passing through the rotation center C3 of the movement sleeve 210, developer from the third conveying member 148 adheres to the portion located below this horizontal plane H of the outer peripheral surface 210A of the movement sleeve 210.

The developer that has adhered to the outer peripheral surface 210A of the movement sleeve 210 moves upward due to the rotation of the movement sleeve 210.

Then, in the present embodiment, this developer reaches the regulating unit 300 arranged above the horizontal plane H. When the developer reaches the regulating unit 300, the downstream movement of some of the developer is regulated.

Furthermore, the rest of the developer moves downstream through the gap G1 between the movement sleeve 210 and the regulating unit 300.

Here, regarding when developer is supplied to the developing roller 145, a form is also feasible in which the developing roller 145 is provided adjacent to the third conveying member 148 and developer is supplied directly from the third conveying member 148 to the developing roller 145, for example.

Incidentally, in this case, unevenness is liable to occur in the developer that is supplied from the developing roller 145 to the photoconductor drum 11.

Specifically, when developer is conveyed by the third conveying member 148, a state is entered in which the developer is conveyed while agitated, and when developer is supplied from the third conveying member 148 to the developing roller 145 in this state, unevenness is liable to occur in the developer that adheres to the developing roller 145. In particular, this unevenness is liable to occur when the third conveying member 148 conveys the developer at a high speed.

Then, in this case, unevenness is liable to occur also in the developer that is supplied from the developing roller 145 to the photoconductor drum 11.

In contrast, when the regulating unit 300 that regulates the movement of the developer is provided as in the present embodiment, the developer is smoothed out and unevenness in the developer supplied to the developing roller 145 is reduced.

Then, in this case, unevenness in the developer that is supplied from the developing roller 145 to the photoconductor drum 11 is reduced.

It should be noted that, in the present embodiment, because the regulating surface 310 of the regulating unit 300 faces downward, developer that collides with this regulating surface 310 and has the movement thereof regulated drops downward.

Furthermore, in the present embodiment, the third conveying member 148 is located below the regulating unit 300, and developer that has had the movement thereof regulated by the regulating unit 300 and has dropped is supplied to the third conveying member 148.

In addition, in the present embodiment, as mentioned above, the regulating unit 300 and the third conveying member 148 are arranged in such a way that the regulating unit 300 and the third conveying member 148 overlap when the regulating unit 300 and the third conveying member 148 are viewed from above or below in the vertical direction.

In this case, developer can be supplied to the third conveying member 148 merely by developer that has had the movement thereof regulated by the regulating unit 300 simply dropping downward.

Here, if a configuration is adopted in which the regulating unit 300 and the third conveying member 148 do not overlap when the regulating unit 300 and the third conveying member 148 are viewed from above or below in the vertical direction, a configuration for causing developer that has dropped due to the regulating unit 300 to move toward the third conveying member 148 is additionally required.

In contrast, this configuration for causing the developer to move can be omitted if a configuration is adopted in which the regulating unit 300 and the third conveying member 148 overlap when the regulating unit 300 and the third conveying member 148 are viewed from above or below in the vertical direction.

Furthermore, in the present embodiment, as depicted in FIG. 2, downstream of the regulating unit 300 in the rotation direction of the movement sleeve 210, there is provided a guide surface 90 that guides the moved developer to the developing roller 145.

That is to say, downstream of the regulating unit 300, there is provided a guide surface 90 that guides developer that has moved through the gap G1 between the movement sleeve 210 and the regulating unit 300, to the developing roller 145.

This guide surface 90 is arranged between the developing roller 145 and the movement roller 200.

Furthermore, the guide surface 90 is arranged in an inclined state with respect to the horizontal direction. More specifically, the guide surface 90 is arranged so as to descend toward the developing roller 145.

Furthermore, the guide surface 90 is provided at the opposite side of the movement roller 200 to the side where the regulating unit 300 is installed.

In addition, in the present embodiment, a configuration is adopted in which the developer that has moved while being guided by the guide surface 90 accumulates in a region located between the outer peripheral surface 145X of the developing sleeve 145A and the guide surface 90 (in the drawing, in a region located more in the direction indicated by the arrow 2Y than the straight line indicated by the reference characters 2X) (in the space located between the outer peripheral surface 145X and the guide surface 90).

With a configuration in which developer is accumulated in this way, the developer is more stably supplied to the outer peripheral surface 145X of the developing sleeve 145A and unevenness in the developer that adheres to the outer peripheral surface 145X of the developing sleeve 145A is reduced, compared to a configuration in which developer is not accumulated.

In addition, the developing device 14 is provided with a layer regulating unit 151 above the developing roller 145. This layer regulating unit 151 is arranged with there being a gap G2 between the layer regulating unit 151 and the developing roller 145. Furthermore, the layer regulating unit 151 is arranged downstream of the guide surface 90 in the rotation direction of the developing sleeve 145A.

The layer regulating unit 151 regulates the movement of some of the developer that has adhered to the outer peripheral surface 145X of the developing sleeve 145A, so that the thickness of the developer that has adhered to the surface of the developing sleeve 145A is a predetermined thickness.

Furthermore, in the present embodiment, developer is caused to accumulate between the layer regulating unit 151 and the guide surface 90. Thus, developer is more stably supplied to the outer peripheral surface 145X of the developing sleeve 145A and unevenness in the developer that adheres to this outer peripheral surface 145X is reduced.

That is to say, in the present embodiment, the layer regulating unit 151 is provided in a position opposing the guide surface 90, and an accumulation space 2Z in which the developer accumulates is present between the guide surface 90 and the layer regulating unit 151.

Thus, developer is more stably supplied to the outer peripheral surface 145X of the developing sleeve 145A and unevenness in the developer that adheres to the outer peripheral surface 145X of the developing sleeve 145A is reduced.

In addition, in the present embodiment, a space G3 is provided between the guide surface 90 and the movement sleeve 210.

In the present embodiment, when a lot of developer has accumulated in the accumulation space 2Z, the developer in the accumulation space 2Z and developer newly supplied from upstream to this accumulation space 2Z drop downward through this space G3.

Thus, developer is less likely to be excessively supplied to the accumulation space 2Z, and, for example, developer is less likely to become clogged due to being compressed and so forth.

Furthermore, in the developing device 14 of the present embodiment, a downward opposing unit 152 that opposes the developing roller 145 is provided below the developing roller 145.

In the present embodiment, the opening 143 is provided between the layer regulating unit 151 and the downward opposing unit 152, and the developing roller 145 is installed in this opening 143.

It should be noted that, hereinabove, an example case has been described in which there is a regulating unit 300 that protrudes above the movement path R of the developer, and a side surface of this regulating unit 300 serves as a regulating surface 310 that regulates the movement of the developer. That is to say, hereinabove, an example case has been described in which there is a protrusion that protrudes above the movement path R, and the movement of the developer is regulated by a surface of this protrusion.

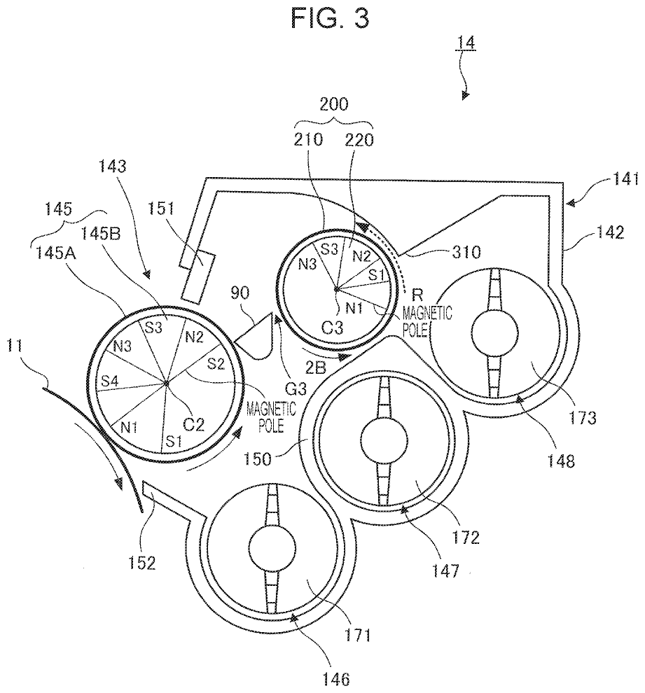

Incidentally, a regulating surface 310 can be set up even if this kind of protrusion is not provided, as depicted in FIG. 3 (a drawing depicting another exemplary configuration of the developing device 14).

In the exemplary configuration depicted in FIG. 3, a section of the inner surface of the housing unit 141 extends in a direction intersecting the movement direction of the developer, and this section of the inner surface serves as the regulating surface 310 that regulates the movement of the developer.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A developing device comprising:
a housing unit that has an opening and houses a developer;
a conveying member that is installed within the housing unit and conveys the developer;
a first rotating member that has an outer peripheral surface to which the developer conveyed by the conveying member adheres;
a regulating unit that protrudes above a movement path of the developer that adheres to the outer peripheral surface and moves due to rotation of the first rotating member, and regulates movement of some of the developer on the outer peripheral surface; and
a second rotating member that is installed in the opening and has supplied thereto the developer that has moved through a gap between the first rotating member and the regulating unit.

2. The developing device according to claim 1,
wherein the regulating unit is installed at an opposite side of the first rotating member to a side where the second rotating member is installed.

3. The developing device according to claim 1,
wherein a regulating surface, which regulates the movement of the developer, of the regulating unit is arranged with there being a gap between the regulating surface and the outer peripheral surface of the first rotating member, and extends in a direction away from the outer peripheral surface.

4. The developing device according to claim 1,
wherein the first rotating member is formed in a cylindrical shape,
a magnetic pole for causing the developer to adhere to the outer peripheral surface of the first rotating member is provided at an inner side of the first rotating member, and
the regulating unit is arranged in a position opposing the magnetic pole with the first rotating member therebetween.

5. The developing device according to claim 1,
wherein a regulating surface, which regulates the movement of the developer, of the regulating unit faces downward.

6. The developing device according to claim 1,
wherein the developer that has had the movement thereof regulated by the regulating unit drops and is supplied to the conveying member.

7. The developing device according to claim 6,
wherein the regulating unit and the conveying member are provided in such a way that the regulating unit and the conveying member overlap when the regulating unit and the conveying member are viewed from above or below in a vertical direction.

8. The developing device according to claim 1,
further comprising a guide surface that is arranged between the second rotating member and the first rotating member, and guides to the second rotating member the developer that has moved through a gap between the first rotating member and the regulating unit.

9. The developing device according to claim 8,
wherein the developer that has moved while being guided by the guide surface accumulates in a region located between an outer peripheral surface of the second rotating member and the guide surface.

10. The developing device according to claim 9,
wherein there is a gap between the guide surface and the first rotating member.

11. The developing device according to claim 8,
wherein the guide surface is installed at an opposite side of the first rotating member to a side where the regulating unit is installed.

12. A developing device comprising:
a housing unit that has an opening and houses a developer;
a conveying member that is installed within the housing unit and conveys the developer;
a first rotating member that has an outer peripheral surface to which the developer conveyed by the conveying member adheres;
a regulating surface that is arranged with there being a gap between the regulating surface and the outer peripheral surface of the first rotating member, extends in a direction away from the outer peripheral surface, and regulates movement of some of the developer that has adhered to the outer peripheral surface; and
a second rotating member that is installed in the opening and has supplied thereto the developer that has moved through the gap located between the outer peripheral surface and the regulating surface.

13. An image forming device comprising:
an image carrier that carries an image;
a developing device that causes a developer to adhere to the image carrier and forms an image on a surface of the image carrier; and
a transfer unit that transfers the image formed on the surface of the image carrier to a recording material,
wherein the developing device is constituted by the developing device according to claim 1.
